(19) United States
(12) Patent Application Publication
(10) Pub. No.: US 2026/0087773 A1
(43) Pub. Date: Mar. 26, 2026

(54) Text-Detector Guided Video Encoding

(71) Applicant: ATI Technologies ULC, Markham (CA)

(72) Inventors: Syed Yousuf Ali, Richmond Hill (CA); Gabor Sines, Toronto (CA); Feng Pan, Richmond Hill (CA); Wei Gao, Aurora (CA); Ihab Amer, Stouffville (CA); Haibo Liu, North York (CA)

(21) Appl. No.: 18/895,649

(22) Filed: Sep. 25, 2024

(51) Int. Cl. G06V 10/74; H04N 19/119; H04N 19/159

(52) U.S. Cl. CPC G06V 10/761; H04N 19/119; H04N 19/159

(57) ABSTRACT

Systems and methods described herein for encoding of video frames based on an amount of text contained within each block of the frame. For each frame, text detection is performed to identify text contained within each block of the frame and each pixel position within the frame. The text detection outputs, for each block and pixel position, an amount of textual content with respect to a preset threshold amount. Based on the output, only the blocks and pixel positions having an amount of text content equal to or greater than the threshold amount are selected as candidates for block matching. For other blocks block matching processes are bypassed.

### BACKGROUND

### Description of the Related Art

Various techniques can be used to compress video data, which are performed according to one or more video coding standards. Examples of these standards include High Efficiency Video Coding (HEVC), Advanced Video Coding (AVC), and Moving Picture Experts Group (MPEG) coding, among others. Video coding typically employs prediction methods, such as inter-prediction and intra-prediction, to exploit redundancy in video images or sequences. A key objective of video coding techniques is to reduce the bit rate of the video data while minimizing any loss in video quality.

Intra prediction using Intra block copy (Intra BC) is one technique used to encode video data. One step used in Intra BC encoding is block-matching. Block-matching seeks to find a match for a current block being encoded within the valid regions. With typical solutions, this step is responsible for much of the complexity in the entire Intra BC encoding process. Although the quality gains are substantial, such results are obtained only when a full search of the available valid area is performed for all the blocks. The computational complexity of such full search can makes Intra BC impractical for real time encoding.

In view of the above, improved systems and methods for video encoding using intra block copy (Intra BC) based prediction modes are needed.

### BRIEF DESCRIPTION OF THE DRAWINGS

The advantages of the methods and mechanisms described herein may be better understood by referring to the following description in conjunction with the accompanying drawings, in which:

FIG. 1 is a block diagram of one implementation of a computing system.

FIG. 2 illustrates a schematic representation of a video encoder.

FIG. 3 illustrates a video processing system.

FIG. 4 illustrates detection of text in a frame of video to be encoded.

FIG. 5 illustrates a video frame encoding process using an output from a text detection operation.

FIG. 6 illustrates using text detection with hash-based block matching for frame encoding.

FIG. 7 illustrates a method for selecting a prediction mode for encoding a source frame.

FIG. 8 illustrates a method for block matching when encoding a source frame.

### DETAILED DESCRIPTION OF IMPLEMENTATIONS

In the following description, numerous specific details are set forth to provide a thorough understanding of the methods and mechanisms presented herein. However, one having ordinary skill in the art should recognize that the various implementations may be practiced without these specific details. In some instances, well-known structures, components, signals, computer program instructions, and techniques have not been shown in detail to avoid obscuring the approaches described herein. It will be appreciated that for simplicity and clarity of illustration, elements shown in the figures have not necessarily been drawn to scale. For example, the dimensions of some of the elements may be exaggerated relative to other elements.

Systems and methods for encoding of video frames based on an amount of text or text-like components contained within each block of the frame, are disclosed. As described hereinafter “text-like components” can include, without limitation, glyph-like patterns that have a characteristic line-form and having a contrast against a background color. These components have a high probability of repetition within a particular frame. In one or more implementations, to reduce computational overheads while maintaining appropriate quality levels of encoding, methods for frame encoding are described herein that combine text detection with intra prediction methods such as Intra BC. In one such implementation, text detection is performed, for each block within a frame to be encoded, to identify text contained within these blocks. The text detection can allow encoder(s) to determine areas of text-like content within the frame and to treat these areas separately from areas of non-text content. The encoder initiates a text detector to execute a text detection operation, e.g., when a first prediction mode (e.g., Intra BC) is selected as the preferred mode of encoding the frame. The text detection operation outputs, for each block, an amount of textual content with respect to a preset threshold amount. Based on the output, only the blocks having an amount of text content equal to or greater than the threshold amount are processed using the first mode of prediction. Other blocks in the frame are then encoded using a second prediction mode different than the first prediction mode. Text-detection is further used to select blocks for hash-based block matching during the encoding of the frame. These and other implementations are described in detail in the subsequent description.

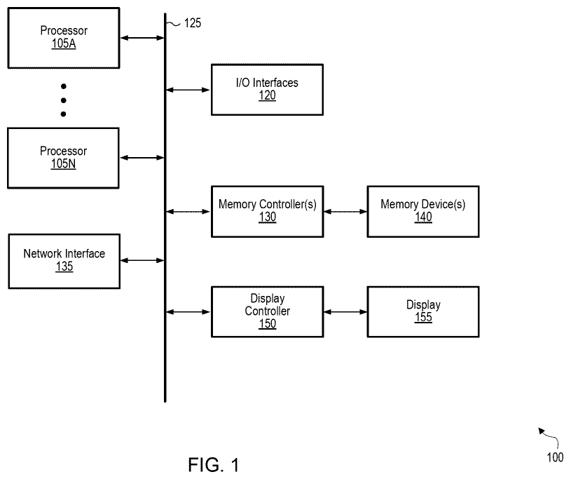

Referring now to FIG. 1, a block diagram of one implementation of a computing system 100 is shown. In an implementation, computing system 100 is configured to, amongst other functionalities, process data, such that but not limiting to, unprocessed image data received from one or more imaging devices and/or content captured from display devices (“screen content”). “Screen content” in the context of video coding applications refers to visual information displayed on computer screens, mobile devices, or other digital interfaces. Screen content can include text, graphics, animations, and user interface elements. This type of content is characterized by sharp edges, significant repetition, and high contrast between elements. Effective video coding for screen content is crucial in applications such as remote desktop sharing, video conferencing, online gaming, and virtual classrooms, where preserving the clarity and readability of text and graphics is essential for a seamless user experience.

The system 100 is configured to identify pixels in a raw image pattern and process the raw image pattern to create display-ready images. Additionally, the system 100 is configured to process data pertaining to static images and dynamic images (like videos) for a diverse range of camera-enabled devices, such as digital cameras, electronic devices with built-in digital cameras (e.g., mobile devices and laptop computers), security or video surveillance setups, medical imaging systems, and other devices operating in similar contexts.

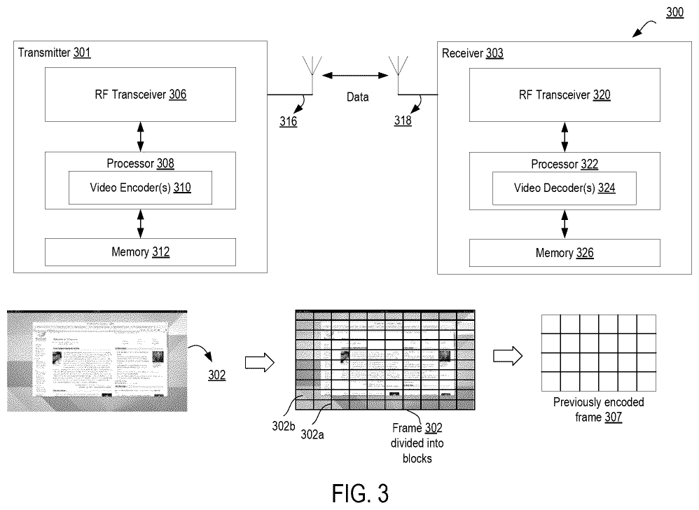

In one or more implementations, the system 100 encompasses a video coding system which implements intra prediction and/or inter prediction involving techniques for encoding video data by predicting values of pixels within a video block or frame. This prediction is based on the analysis of neighboring pixels or blocks within the same frame, without reference to external frames or images. The system 100 employs various intra prediction modes, e.g., Intra block copy (Intra BC), DC mode, planar mode, angular modes, etc. to estimate pixel values. Intra BC is a type of intra prediction mode used primarily in video compression, particularly in the context of newer video coding standards such as the Versatile Video Coding (VVC) standard (H.266). In one implementation, unlike traditional intra prediction modes, which predict blocks based on neighboring pixels within the same frame, Intra BC predicts blocks by copying from other regions within the same frame. This technique is particularly useful for coding screen content, such as computer graphics and text, where repeated patterns and textures are common. These and other implementations are explained in detail with respect to subsequent FIGS. 3-7.

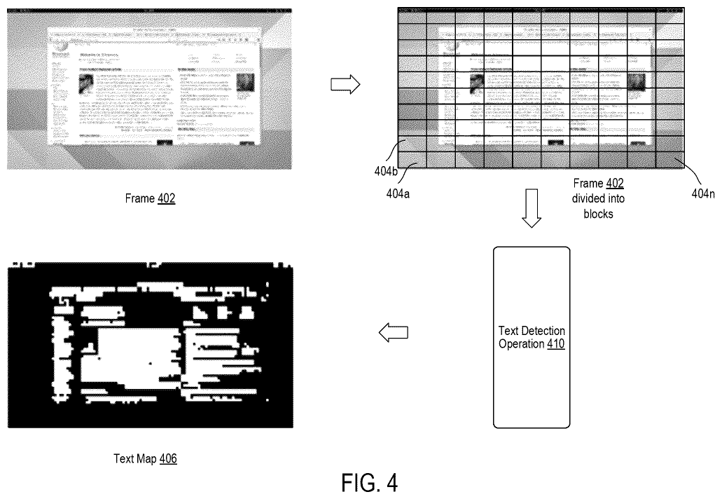

In one implementation, computing system 100 includes at least processors 105A-N, input/output (I/O) interfaces 120, bus 125, memory controller(s) 130, network interface 135, memory device(s) 140, display controller 150, and display 155. In other implementations, computing system 100 includes other components and/or computing system 100 is arranged differently. Processors 105A-N are representative of any number of processors which are included in system 100. In several implementations, one or more of processors 105A-N are configured to execute a plurality of instructions to perform functions as described with respect to FIGS. 4-8 herein.

In one implementation, processor 105A is a general-purpose processor, such as a central processing unit (CPU). In one implementation, processor 105N is a data parallel processor with a highly parallel architecture. Data parallel processors include graphics processing units (GPUs), digital signal processors (DSPs), field programmable gate arrays (FPGAs), application specific integrated circuits (ASICs), and so forth. In some implementations, processors 105A-N include multiple data parallel processors. In one implementation, processor 105N is a GPU which provides pixels to display controller 150 to be driven to display 155.

Memory controller(s) 130 are representative of any number and type of memory controllers accessible by processors 105A-N. Memory controller(s) 130 are coupled to any number and type of memory devices(s) 140. Memory device(s) 140 are representative of any number and type of memory devices. For example, the type of memory in memory device(s) 140 includes Dynamic Random Access Memory (DRAM), Static Random Access Memory (SRAM), NAND Flash memory, NOR flash memory, Ferroelectric Random Access Memory (FeRAM), or others.

I/O interfaces 120 are representative of any number and type of I/O interfaces (e.g., peripheral component interconnect (PCI) bus, PCI-Extended (PCI-X), PCIE (PCI Express) bus, gigabit Ethernet (GBE) bus, universal serial bus (USB)). Various types of peripheral devices (not shown) are coupled to I/O interfaces 120. Such peripheral devices include (but are not limited to) displays, keyboards, mice, printers, scanners, joysticks or other types of game controllers, media recording devices, external storage devices, network interface cards, and so forth. Network interface 135 is used to receive and send network messages across a network.

In various implementations, computing system 100 is a computer, laptop, mobile device, game console, server, streaming device, wearable device, or any of various other types of computing systems or devices. It is noted that the number of components of computing system 100 varies from implementation to implementation. For example, in other implementations, there are more or fewer of each component than the number shown in FIG. 1. It is also noted that in other implementations, computing system 100 includes other components not shown in FIG. 1. Additionally, in other implementations, computing system 100 is structured in other ways than shown in FIG. 1.

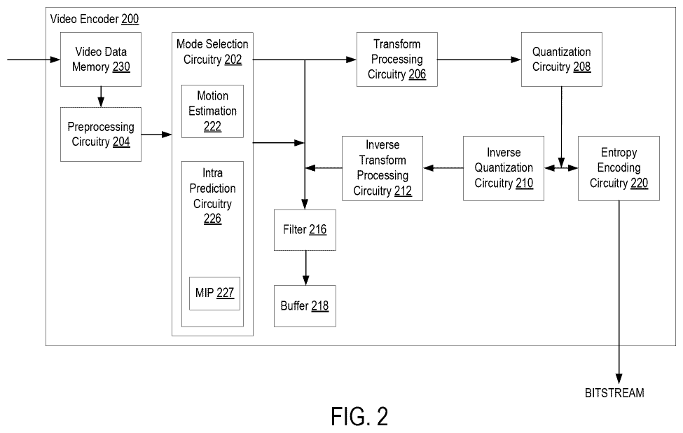

FIG. 2 depicts a schematic representation of a video encoder 200. It is noted that the illustration in FIG. 2 is for explanatory purposes and should not be seen as restricting the broader techniques exemplified and discussed in this disclosure. The disclosure, in its explanation, discusses video encoder 200 within the context of video coding standards like HEVC. In one or more implementations, the video encoder 200 is integral to one or more video coding apparatuses, such as but not limited to, Application-Specific Integrated Circuits (ASICs), Graphics Processing Units (GPUs), camera devices, streaming devices, gameplay devices, professional encoder/decoder devices, and the like.

The video encoder 200 comprises various components, including video data memory 230, mode selection circuitry 202, transform processing circuitry 206, quantization circuitry 208, inverse quantization circuitry 210, inverse transform processing circuitry 212, filter circuitry 216, decoded picture buffer (DPB) 218, and entropy encoding circuitry 220. Any of these components can be implemented within one or more processors or processing circuitry. Additionally, video encoder 200 may incorporate alternative processors or processing circuitry to carry out these functions. For example, as shown, the intra-prediction circuitry 226 may feature a MIP circuitry 227.

Within this document, “video data memory 230,” should not be construed as exclusively referring to memory that is either contained within the video encoder 200 (unless explicitly specified) or external to the video encoder 200 (again, unless specifically mentioned). Instead, video data memory 230 is meant to encompass memory used for storing video data that the video encoder 200 receives for the purpose of encoding, such as video data associated with the current block undergoing encoding.

Video data memory 230 is configured to store incoming video or image data. In one implementation, preprocessing circuitry 204 can access the unprocessed frames within the video or image data from memory 230, and performs initial pre-processing tasks, e.g., noise reduction, color space conversion, and scaling before passing the data on to subsequent stages like motion estimation and compression. This preprocessed data can then be forwarded to mode selection circuitry 202. The mode selection circuitry 202, in line with a hierarchical tree structure, like the QTBT structure or the quad-tree structure found in HEVC, can subdivide a CTU from the image. As described herein, the video encoder 200 can create one or more Coding Units (CUs) by dividing a CTU based on this tree structure. Such a CU can also be commonly referred to as a ‘coding block’ or simply a ‘block’.

Typically, the mode selection circuitry 202 manages its individual components, including motion estimation circuitry 222 and intra-prediction circuitry 226. These components collaborate to produce a prediction block for the current block, which could be the current CU or, in the case of HEVC, the overlapping section of a Prediction Unit (PU) and a Transform Unit (TU). In the context of intra-prediction involving predictions within the same frame, the intra-prediction circuitry 226 has the capability to create a prediction block using data from nearby areas around the current block. To illustrate, when employing directional modes, the intra-prediction circuitry 226 typically combines neighboring sample values mathematically and then fills the current block in the specified direction with these calculated values to form the prediction block. In another scenario, such as the DC mode, the intra-prediction circuitry 226 calculates the average value of neighboring samples relative to the current block and incorporates this resulting average for each sample within the prediction block.

The motion estimation circuitry 222 can create one or more motion vectors (MVs), which specify the locations of the reference blocks in the reference pictures in relation to the location of the current block in the current picture. MIP circuitry 227 utilizes a MIP mode for the production of a prediction block for the current block.

In an implementation, an unprocessed and non-encoded form of the current block from video data memory 230 and the prediction block from mode selection circuitry 202 is used to compute differences on a per-sample basis between the current block and the prediction block. These individual differences, sample by sample, establish a residual block associated with the current block. The transform processing circuitry 206 utilizes one or more transformations on the residual block to create a set of transform coefficients, referred to as a ‘transform coefficient block.’ The transform processing circuitry 206 has the flexibility to apply different types of transformations to the residual block in order to produce the transform coefficient block. Quantization circuitry 208 is capable of performing quantization on the transform coefficients within a transform coefficient block, resulting in the production of a quantized transform coefficient block. The inverse quantization circuitry 210 and inverse transform processing circuitry 212 can be employed to reverse the quantization process and apply inverse transformations to a quantized transform coefficient block. This procedure aims to reconstruct a residual block from the transform coefficient block.

The filter 216 has the capability to execute one or more filtering procedures on the reconstructed blocks. As an illustration, the filter 216 can carry out deblocking operations to mitigate blocked artifacts that may be present along the edges of coding units. The entropy encoding circuitry 220 is responsible for encoding syntax elements it receives from various functional components within the video encoder 200. For instance, it can perform entropy encoding on quantized transform coefficient blocks obtained from quantization circuitry 208. Additionally, the entropy encoding circuitry 220 can encode prediction-related syntax elements, such as motion data for inter-prediction or intra-mode information for intra-prediction, which are provided by the mode selection circuitry 202. The video encoder 200 can produce a bitstream that contains the entropy-encoded syntax elements required to rebuild slices or pictures, with the entropy encoding unit 220 being responsible for generating and outputting this bitstream, specifically.

In various implementations, video encoder 200 serves as an illustrative instance of a device designed for video data encoding. This device incorporates a memory for video data storage and employs one or more processors integrated into its circuitry, which are configured to execute any of the methods outlined in this disclosure. It is noted that even though one or more components of the video encoder 200 are disclosed as having specific hardware implementations, functionalities of these components can also be built in software.

FIG. 3 illustrates a video processing system 300. The video processing system 300 (or system 300) includes at least a first communication device (e.g., transmitter 301) and a second communication device (e.g., receiver 303) capable of communicating with each other over a limited bandwidth connection. In some embodiments, this connection is wired, while in other embodiments, like the one shown, it is wireless. It should be noted that transmitter 301 and receiver 303 can also be referred to as transceivers. These devices represent any type of communication or computing devices. For instance, in various implementations, transmitter 301 and/or receiver 303 could be a mobile phone, tablet, desktop computer, laptop, server, head-mounted display (HMD), television, another type of display, router, or other types of computing or communication devices.

In various configurations, the transmitter 301 sends video information to the receiver 303, such as rendered data corresponding to frame 302. Frame 302 can display a wide range of visual information, such as a scene from a sporting event, a video game scene, and more. The transmitter 301 consists of various processing circuitries and memory devices for implementing processor 308 and memory 312. For instance, processor 308 can include different types of processors, such as a general-purpose central processing unit (CPU), a graphics processing unit (GPU), an accelerated processing unit (APU), an application-specific integrated circuit (ASIC), a field-programmable gate array (FPGA), video encoders (310), and others. Further, memory 312 can use several types of memory, including different types of synchronous random access memory (SRAM), various types of dynamic random access memory (DRAM), hard disk drives (HDDs), solid-state drives (SSDs), and more.

In one or more implementation, the processor 308 features a video encoding pipeline. In other cases, this pipeline is external to the processor 308. The processing pipeline handles, for the frame 302, pixel value calculations, vertex transformations, and other graphics operations like color management, ambient-adaptive pixel (AAP) modification, dynamic backlight control (DPB), panel gamma correction, and dithering. Further, the video encoder(s) 310 are configured to compress a video stream before sending it to the receiver 303. The video encoder(s) 310 can be implemented using a mix of hardware, such as circuitry for combinatorial logic and sequential elements, and/or software, such as firmware. The video encoder(s) 310 creates bits for a bitstream and stores them in a buffer.

It should be noted that the RF transceiver 306 is depicted as a single unit solely for illustration purposes. In various implementations, transmitter 301 can consist of any number of different units (e.g., chips) depending on how the RF transceiver 306 is configured. Transmitter 301 also features antenna 316 for transmitting and receiving RF signals. Antenna 316 can include one or multiple antennas, such as a phased array, a single-element antenna, or a set of switched beam antennas, which can be adjusted to modify the directionality of radio signal transmission and reception. For example, antenna 316 might include one or more antenna arrays, with the amplitude or phase of each antenna in the array being independently adjustable from the others. While antenna 316 is depicted as external to transmitter 303, in other implementations, it may be integrated internally within the transmitter. Moreover, transmitter 301 may be included in numerous other components not shown here to keep the illustration clear. Similarly, the components within receiver 303, such as RF transceiver 320, processor 322, video decoder(s) 324, memory 326, and antenna 318, have functionalities similar to those described for transmitter 301. It is also possible for receiver 303 to include or be connected to additional components, like a display. Such implementations are contemplated.

In an implementation, during encoding of video and image data, a key step in the process is block-matching, i.e., trying to find a best match for a current block being encoded within valid regions of a frame. For instance, when encoding frames using Intra block copy (Intra BC) mode, the video encoder(s) 310 matches previously encoded blocks to a block currently being encoded within the frame 302 to identify similar content. For Intra BC encoding, only those regions of the frame that have already been encoded and reconstructed are considered as valid regions for searching the best match. Intra BC can provide performance enhancement benefits in use cases such screen sharing, since this kind of content is usually characterized by large areas of repeated patterns (e.g., characters or letters).

In video sequences, consecutive frames often have similar content with only slight differences due to motion. Block matching aims to identify these similarities and differences to reduce the amount of data that needs to be encoded. As depicted, frame 302 is divided into blocks, e.g., by rectangular blocks 302a-302n (e.g., each block representing ‘n’ pixels). For each block in the frame 302, a matching block is searched in a reference frame 307 (e.g., a previously encoded frame). This search identifies a motion vector that represents the displacement of a current block (e.g., block 302a) from the reference frame 307 to the current frame 302.

In one implementation, a search area is defined in the reference frame 307 where the matching block is likely to be found. Further, using a matching criterion, such as Sum of Absolute Differences (SAD) or Mean Squared Error (MSE), the current block 302a with candidate blocks of the frame 307, within the search area. A candidate block that best matches the current block 302a, is selected and a motion vector is defined which is indicative of a displacement between the current block 302a and the best matching block. The motion vectors are used to predict the current frame 302 from the reference frame 307 and encode the differences.

Block matching is widely used in standards like H.264, HEVC, and VP9 to reduce the bitrate while maintaining video quality. Block matching can further aid in predicting motion for various applications, including video stabilization and frame interpolation. However, block matching processes during encoding are responsible for most of the complexity in the video coding pipeline. Although quality gains are realized using particular prediction modes, such as Intra BC, it is noted that such results are obtained when a full search of the available valid area is performed for all the blocks. The computational complexity of such full searches makes it impractical for real time encoding. One approach is the use of hash-based block matching as an alternative method. Whereas this provides benefit on the performance side, however, in terms of quality gains this method trails behind cost-based block matching methods.

In one or more implementations, in order to reduce computational overheads while maintaining appropriate quality levels of encoding, methods for frame encoding are described herein that utilize text detection to select blocks in a frame as candidates for block matching. In one such implementation, text detection is performed, for each block within a frame to be encoded, to identify text contained within the blocks. The text detection can allow encoder(s), such as encoder 310, to determine areas of text and/or text-like content within the frame and to treat these areas separately from areas of non-text content. The video encoder 310 can either initiate a text detector (not shown) to execute a text detection operation or access text detection data from other processes such as video and image analysis, natural language processing pipelines, and/or other data processing pipelines.

The results of the text detection operation is then used to compare, for each block, an amount of textual content with respect to a preset threshold amount. Based on this comparison, only the blocks having an amount of text or text-like content equal to or greater than the threshold amount are selected as candidates for block matching. Other blocks in the frame are not considered for block matching during encoding. These and other implementations are described in detail in the subsequent description.

FIG. 4 illustrates detection of text in a frame of video to be encoded. As described in the foregoing, using text detection to select candidate blocks for block matching during various prediction modes, such as intra BC mode, can result in an increase in the overall computational efficiency of the encoding process, without substantially compromising the quality of the encoding process.

In an implementation, a video encoder (e.g., video encoder 200) receives a source frame 402 for processing. The source frame 402 refers to an original frame of video that is being encoded or processed. The source frame 402 is an uncompressed frame from which the video encoder derives prediction and encoding data. In an example, the source frame 402 serves as the basis for generating predicted frames, which helps reduce the amount of data required to represent a video sequence. Further, by comparing the source frame 402 with predicted frames, the video encoder can identify and eliminate redundancies, allowing for more efficient compression. This process typically involves techniques such as intra-frame prediction, inter-frame prediction, and motion compensation.

In an implementation, the source frame 402 (hereinafter referred to as ‘frame 402’) is initially divided into individual coding units or blocks 404. Dividing the frame 402 into individual blocks (404a-404n) includes dividing the frame 402 into smaller rectangular regions. This division is performed such that smaller portions of the frame 402 need to be processed, making the encoding process more efficient. In one or more implementations, sizes of the blocks 404 can vary in size, e.g., 8×8, 16×16, or 32×32 pixels. Multiple operations are performed for each block 404 individually, such as, spatial prediction, transformation, quantization, and entropy coding. For spatial prediction, the encoder predicts the pixel values of a current block (e.g., block 404a) using the pixels from neighboring blocks (e.g., block 404b) within the frame 402. After prediction, the residual (the difference between the predicted block and the actual block) is transformed, e.g., using methods like Discrete Cosine Transform (DCT) to convert spatial domain data into frequency domain data. The transformed coefficients are then quantized to reduce precision and compress the data further. The quantized coefficients are then encoded using entropy coding methods such as Huffman coding or Arithmetic coding to produce a compressed bitstream (as shown in FIG. 2). During decoding, encoded bitstream is decoded to reconstruct the quantized coefficients, which are then inverse transformed and added to the predicted block to obtain the final decoded block.

As described, the video encoder is configured to perform spatial prediction on a current video block (e.g., block 404 a), within a given frame, such as frame 402. This method allows the video encoder to predict pixels of the current video block using pixels from one or more previously coded neighboring blocks (e.g., 404 b) of the same video frame 402, known as “prediction blocks. ” The pixels in the neighboring blocks are often highly correlated with those in the current block, because the video frame 402 may have regions with smoothly varying intensity. Consequently, spatial prediction helps the video encoder eliminate certain spatial redundancies in the current block 404a, allowing it to encode only the residual pixels that cannot be spatially predicted. Examples of spatial prediction methods include intra prediction and intra block copy prediction (IBC). Intra prediction uses previously coded pixel samples (e.g., a column or row of samples) from the same frame to predict specific sample values. IBC prediction uses a block of previously coded samples from the same frame to predict the values for an entire block.

In one implementation, prior to the frame 402, divided into individual blocks 404, is encoded, a text detector (not shown) can be initiated by the video encoder to perform a text detection operation 410 on the divided frame 402. In one example, the text detector can be initiated every time a new frame needs to be encoded. The text detection operation 410 can include initiating an open-source optical character recognition (OCR) engine to detect textual components within each block 402 of the frame. The text detection operation 410 can further include initiating vision libraries that provide tools for preprocessing, edge detection, and morphological operations. Further, convolution neural network (CNN) based models like EAST (Efficient and Accurate Scene Text) or CRNN (Convolutional Recurrent Neural Network) can also be used for text detection and recognition. In one or more alternate implementations, other text detection operation(s) are originally performed at other stage(s) within a video coding pipeline or alternate processing pipelines outside the video coding pipelines, such that results from these text detection operation(s) can be used by a video coding apparatus, as described herein. For example, text detection results can be accessed using other processing pipelines such as video and image analysis, natural language processing pipelines, and/or other data processing pipelines. In one or more implementations, within the video coding processing pipeline, the text detection operation 410 can be performed using one or more dedicated processing circuitries such as but not limited to GPUs, FPGAs, ASICs, or the like.

In an implementation, the text detection operation 410 is performed for each individual block 404 of the frame 402. The text detection operation 410 outputs a text map 406 that represents, on a per-block basis, which blocks 404 in the frame 402 are identified as containing text or text-like content. In one implementation, the text map 406 is generated based on a comparison of an amount of textual content within each block to a threshold amount. This threshold amount can be configured within the encoder settings, e.g., based on quality metrics associated with various applications and use cases. In one example, the quality metrics can include resolution of a source frame to be encoded. In another example, the quality metrics can include encoding the frame based on variations in brightness in different blocks of the frame, e.g., for text occurring as high contrast areas. Other implementations are contemplated. Based on the comparison, the blocks having an amount of text or text-like components exceeding the threshold can be marked as blocks containing text.

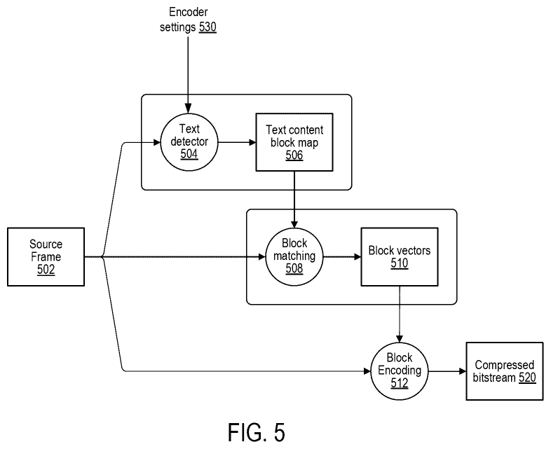

The text map 406 can be represented using a data structure including, for each text block, a unique label or reference to distinguish and address the text block from other blocks within the frame 402 during encoding and decoding processes. The data structure can further include a currently set threshold amount and a detected amount of text within each text block, with respect to the current threshold. Once the text map 406 is generated, the map can be fed to the encoding logic. In an implementation, the encoding logic selects blocks 404 marked as text blocks by virtue of the text map 406, as candidates for block matching during a prediction process. Further, for blocks that are not marked as text blocks, i.e., blocks identified as having no textual components or an amount of text below the threshold amount, a block matching process may not be performed. In one example, such selection is advantageous in reducing computational resources and encoding costs in particular prediction modes, e.g., Intra BC mode, wherein finding a best matching block to a block currently being encoded within the same frame is necessary. An example encoding process, using text detection, is detailed in FIG. 5.

FIG. 5 illustrates a video frame encoding process using an output from a text detection operation. As described with respect to FIG. 5, a video encoder (e.g., video encoder 200) receives a source frame 502 for processing. The frame 502 is an original frame of video that is being encoded or processed. By comparing the frame 502 with predicted frames, the video encoder can identify and eliminate redundancies, allowing for more efficient compression. This process typically involves techniques such as intra-frame prediction, inter-frame prediction, and motion compensation. In one implementation, the video encoder divides the frame 502 into individual coding units or blocks. In one or more implementations, sizes of the blocks can vary in size, e.g., 8×8, 16×16, or 32×32 pixels. Multiple operations are performed for each block individually, such as, spatial prediction, transformation, quantization, and entropy coding.

In one implementation, when the frame 502 is queued for being encoded the video encoder can utilize output from a text detection operation 504 to determine an amount of text or text-like components found within each block of the frame 502. In an implementation, the amount of text for each block is outputted in the form of a text content block map 506, which can be a data structure that includes the amount of text for each block, as compared to a preset threshold amount, and a unique identifier for each block. In one implementation, the video encoder compares the amount of text detected in each block with a preset threshold amount to determine whether the block is a candidate for block matching when processed using a given prediction mode. The preset threshold amount can be configured for various use cases and/or application, e.g., as directed by various encoder settings 530.

Based on this comparison, the text content block map 506 is generated, which is representative of an amount of text or text-like components identified in each block of the frame 502. During the encoding process, e.g., before a block matching process 508 is initiated, the text content block map 506 can be used by the video encoder to select candidate blocks for the block matching process 508. In one implementation, the block matching process 508 includes defining a search range within the frame 502 where potential matching blocks can be found. The process further includes identifying blocks within the defined search range, such that these blocks can be considered as potential matches for the current block to be predicted.

In one implementation, when the source frame 502 is to be encoded as an intra frame, the block matching process 508 is performed only for blocks that contain an amount of text greater than or equal to the preset threshold amount. These matched blocks are further processed by the video encoder to generate block vectors 510. These block vectors 510 are subsequently used by the video encoder to copy pixels from a reference block to a current block during encoding. Further, residual values can be computed to generate residual blocks. Each residual block is transformed (e.g., using Discrete Cosine Transform) and quantized to reduce the data size. The video encoder can encode these blocks through a block encoding process 512 to generate the compressed bitstream 520. In one implementation, only blocks having text or text-like components are encoded using a particular prediction mode, e.g., Intra BC mode. In another implementation, for blocks having no amount of text or an amount of text that is less than the threshold, the block matching process 508 is bypassed. In the example shown in the figure, for such blocks, the video encoder can bypass the block matching process 508 during a block encoding process 512, e.g., to generate the compressed bitstream 520.

Using methods described herein, encoding performance can be increased, e.g., due to reduction in the number of blocks being processed using a particular prediction mode, e.g., intra BC mode. In terms of performance improvement, using text detection to select prediction mode results in benefits that depend on the size of text-content areas in the frame 502, without any substantial compromise to the encoding quality.

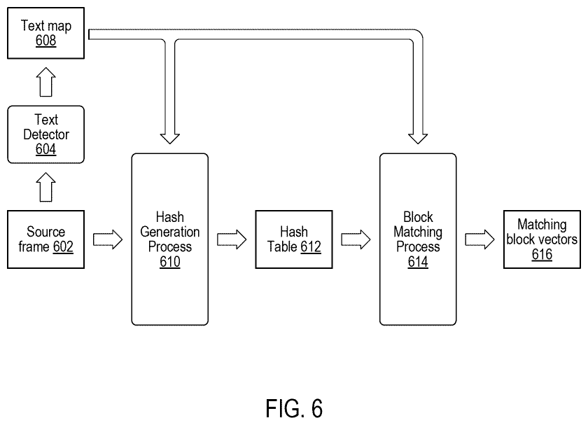

FIG. 6 illustrates using text detection with hash-based block matching for frame encoding. In screen content video applications, objects moving across pictures may not follow an optical flow model, as they do in camera-captured contents. As a result, the best matching reference block for a block being currently inter or intra coded, can be distant from a collocated position in the reference frame, or even irrelevant to the motion vector predicted position. However in such applications, many repetitive textures exist within the same frame. When performing intra prediction, conventional methods may not achieve a substantial coding efficiency due to the complexity and irregular shape of the content.

Traditionally, to remedy such issues, hash-based block matching methods have been introduced, that match a current block's “hash key” with those in the reference blocks. Hash-based block matching is a technique used in image processing, that involves using hash functions to simplify the process of matching blocks of pixels between frames. This method helps in efficiently finding corresponding blocks, reducing the computational load compared to direct pixel-by-pixel comparisons. This method can involve dividing the frame into smaller blocks and finding corresponding blocks in another frame (in case of inter prediction) or the same frame (in case of intra prediction) that match the current block. A function is generated, that maps the pixel values of a block to a hash key. This key represents the block in a compact form and uniquely identifies the block based on its pixel values.

Hash-based block matching methods can be computationally cheaper than the block-based matching methods, since only blocks with the same hash key need to be compared. For each reference frame, a hash key is generated for each block. A hash table is then generated for blocks of the same key. In hash-based blocking matching method, the hash key of the current block is calculated and only blocks in the hash table having the same key are compared with the current block. This method can usually be split into two main steps: generating a hash table for the entire reference frame, and finding exact matched blocks in the hash table for each block in current frame.

One key benefit of hash-based schemes is that hash-based block matching methods have lower computation complexities, e.g., during the matching process, and therefore using such methods a full range of matching can be performed rather than a limited search range used by conventional block matching methods. However, for particular applications, it may be still desirable to further reduce the computation complexity with or without an acceptable trade-off in quality. Further risks with hash-based methods can include the increasing size of hash tables and a possibility of hash collisions. Usually, some measurement of spatial complexity can be performed for a given block before hash table generation, with the purpose to determine whether hash value calculations for the block can be skipped. For instance, hash values can be generated only for blocks containing texture-rich content. For other (non-textured) blocks, simple intra prediction methods can be sufficient to encode those blocks efficiently. However, even after skipping hash generation for non-textured blocks, the total number of hash table entries do not get substantially reduced and can still be challenging for practical implementations.

In various implementations described herein, a text detection operation can be used in combination with hash-based block matching methods to increase computational efficiency without having a substantial effect on encoding quality. In conventional hash-based methods, a hash value is computed for each block of a target frame. The hash values are computed in a manner that similar hash values represent visually similar blocks. The computed hash values are then stored in a data structure (e.g., a hash table or an array). During a hash-based block matching process, matching blocks are searched for each block, e.g., by comparing their respective hash values. If hash values of two blocks are sufficiently close (considering the chosen hash function and possible hash collisions), the blocks are considered a match.

In one or more implementations described herein, outputs from a text detection operation can be used to cull hash generation process, thereby reducing the computational resources required to generate the hash table. In one implementation, for each source frame 602, a text detection operation 604 is invoked that outputs a result indicative of an amount of text detected at each pixel position in the frame 602. As described herein, pixel position in a frame refers to specific coordinates of a pixel within a digital image or video frame. In one example, text detection can allow encoder(s) to determine areas of text-like content at each pixel position in the frame 602 and to treat these areas separately from areas of non-text content.

In operation, an output of the text detection operation 604 includes a text map 608, that can be represented using a data structure. The data structure includes values that represent an amount of text calculated per-pixel position within the frame. For example, text is detected for a first pixel position in the frame, the area of which is equal to a block size, e.g. 8×8. This area is covered for text detection, and the text detection is then performed by moving to the next pixel in the frame, to calculate the amount of text for this pixel position. The data structure further includes, for each pixel position within a frame, a unique identifier, and an amount of text or text-like components detected at the pixel position with respect to a preset threshold amount. As described earlier, the preset threshold can be configurable for various applications and/or use cases.

During the encoding process for the source frame 602, a hash generation process 610 is initiated by the encoder to generate hash values for each block of the source frame 602. When such a process is initiated, the text map 608 can be fed into the process to determine which of the reference pixel positions contain text or text-like components. Using this data, the encoder can select candidate blocks within the reference frame 602 for a hash generation process 604. In one implementation, the hash generation process 604 is terminated (or bypassed) for blocks where corresponding pixel positions include no text or text-like components (or where an amount of text detected is lesser than the preset threshold). For blocks where corresponding pixel positions include an amount of text that exceeds the threshold value, hash values are generated and stored in the hash table 612.

In one implementation, using per-pixel position for hash generation, the hash table 612 is significantly culled, since hash values for are not generated for pixel positions where no text is detected. Further, in one implementation, the output of the text detection operation 604, i.e., the text map 608 is further utilized before a block matching process 614 is performed for each current block. According to the implementation, for a given current block being encoded, the text map 608 is used to determine whether the block contains an amount of text or text-like components that is greater than or equal to the preset threshold amount. Based on this determination, a hash-based block matching is terminated (or bypassed) for blocks where no text or text-like components are detected. For these blocks, either no block matching is performed or block matching is performed using one or more other methods such as but not limited to, gradient-based block matching, logarithmic search, or diamond search methods. Further, hash-based block matching is performed only for blocks where a detected amount of text or text-like components exceed or equal the preset threshold. Based on this block matching, block vectors 616 are generated by the video encoder, e.g., to produce a compressed bitstream.

The described methods enable encoding of text-rich blocks to realize coding gains from hash-based block matching. These methods can further provide a smaller hash table size and lower computation complexity over conventional block matching methods, especially when gradient or non-text textured areas are present in the source frame 602.

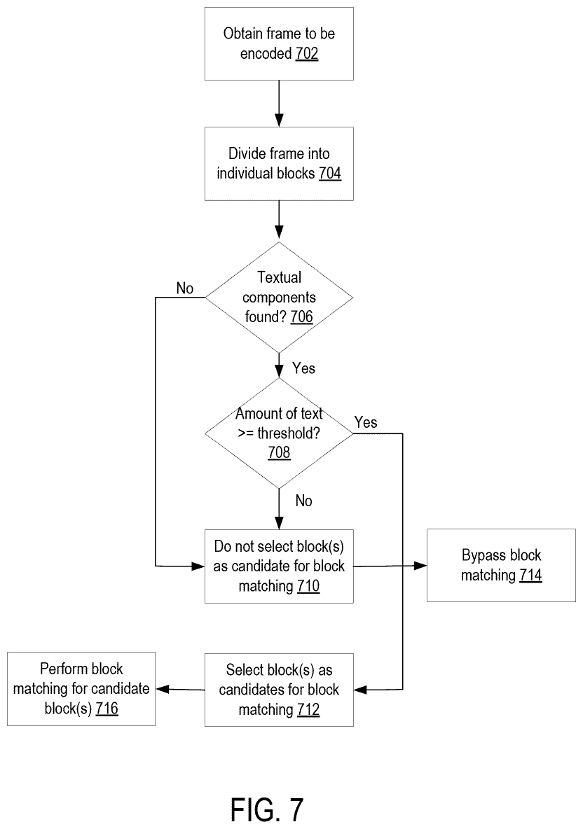

FIG. 7 illustrates a method for selecting candidate blocks of a source frame, for performing block matching, when encoding the source frame. As described with respect to the figure, a video encoding circuitry (e.g., video encoder 200) receives a source frame for processing (block 702), that is an original frame of a video being encoded or processed. By comparing the frame with predicted frames, the video encoding circuitry can compress the frame using intra-frame prediction or inter-frame prediction. In one implementation, the frame is initially divided into individual coding units or blocks (block 704). In one or more implementations, sizes of the blocks can vary in size, e.g., 8×8, 16×16, or 32×32 pixels. Multiple operations are performed for each block individually, such as, spatial prediction, transformation, quantization, and entropy coding.

In one implementation, the video encoding circuitry can utilize output from a text detection operation to determine whether text or text-like components are found within each block (conditional block 706). In one example, the text detection operation can be performed within the video coding pipeline using one or more of GPUs, FPGAs, ASICs, or the like. If text or text-like components are not found (conditional block 706, “no” leg), the method continues to block 710.

However, if text or text-like components are detected in a given block, the amount of text for the block is compared with a preset threshold amount (conditional block 708). If the amount of text is less than the preset threshold amount (conditional block 708, “no” leg), the method continues to block 710. At block 710, the video encoding circuitry generates an indication that indicates that the blocks where text is not detected or an amount of text detected is lesser than the threshold amount, are not to be selected as candidates for the block matching process. During encoding of such blocks, the video encoding circuitry bypasses the block matching process for each block (block 714).

If the amount of text is greater than the preset threshold amount (conditional block 708, “yes” leg), the method continues to block 712. At block 712, the video encoding circuitry generates an indication that indicates that these blocks are selected as candidate for the block matching process. When encoding these blocks, the video encoding circuitry performs the block matching process for each block (block 716).

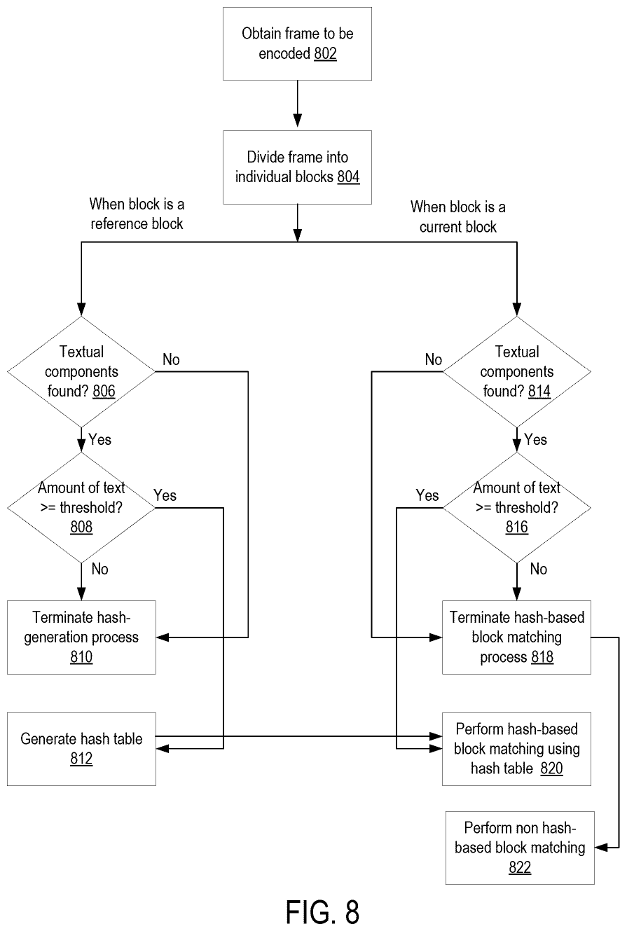

FIG. 8 illustrates a method for block matching when encoding a source frame. In various implementations described herein, a text detection operation can be used in combination with block matching methods to increase computational efficiency without having a substantial effect on encoding quality. It is noted that blocks 806-812 are performed for each pixel position when the frame is a reference frame, whereas blocks 814-822 are performed for each block of the frame, when the frame is a current frame.

As shown in the figure, a source frame is obtained by a video encoding circuitry for processing (block 802). The source frame (hereinafter referred to as ‘frame’) is initially divided into individual coding units or blocks by the video encoding circuitry (block 804). Dividing the frame into individual blocks includes dividing the frame into smaller rectangular regions. This division is performed such that smaller portions of the frame need to be processed, making the encoding process more efficient.

When the source frame is a reference frame, a text detection operation is invoked by the video encoding circuitry, such that the text detection operation can determine whether text or text-like components are detected in each pixel position of the reference frame (conditional block 806). For pixel positions, where no text or text-like components are detected (conditional block 806, “no” leg), a hash-generation process for such pixel positions is terminated or bypassed (block 810). However, if text or text-like components are detected in one or more pixel positions, (conditional block 806, “no” leg), the video encoding circuitry further determines whether an amount of text or text-like components exceeds a preset threshold (conditional block 808) for these pixel positions. If the amount of detected text does not exceed the threshold (conditional block 808, “no” leg), hash-generation process is also terminated or bypassed for these pixel positions (block 810).

However, for each pixel position for which text or text-like components are found (conditional block 806, “yes” leg), and the amount of text or text-like components is equal to or greater than the threshold (conditional block 808, “yes” leg), the video encoding circuitry generates a respective hash value. These hash-values are stored in a hash table (block 812). This hash table can be used for hash-based block matching when processing a current frame.

As shown in the figure, when a current frame is processed, the video encoding circuitry determines whether any of the blocks of the frame include text or text-like components (conditional block 814). In one implementation this is done using outputs from a text detector operation as described in the foregoing. For each current block that includes no text (conditional block 814, “no” leg), a hash-based block matching process is terminated or bypassed (block 818). For such blocks, the video encoding circuitry can perform block matching using non-hash based methods (block 822), e.g., logarithmic search, diamond search etc.

However, if text or text-like components are found in one or more blocks (conditional block 814, “yes” leg), the video encoding circuitry further determines whether the amount of text or text-like components is greater than or equal to a preset threshold (conditional block 816). If the amount of text or text-like components for a block is less than the preset threshold amount (conditional block 816, “no” leg), a hash-based block matching process can be terminated or bypassed for that block (block 818). For such blocks, the video encoding circuitry can perform block matching using non-hash based methods (block 822). Conversely, if it is determined by the video encoding circuitry that the amount of text or text-like components for the block is greater than or equal to the preset threshold amount (conditional block 816, “yes” leg), a hash-based block matching process can be executed for such blocks (block 820), e.g., to match a hash value for the block with hash values corresponding to reference blocks as stored in the hash table. Finally, based on the block matching, i.e., either hash-based or non-hash based block matching processes, the video encoding circuitry generates block vectors respective to each block, e.g., to produce a compressed bitstream.

It should be emphasized that the above-described implementations are only non-limiting examples of implementations. Numerous variations and modifications will become apparent to those skilled in the art once the above disclosure is fully appreciated. It is intended that the following claims be interpreted to embrace all such variations and modifications.

What is claimed is

1. An apparatus comprising:
video encoding circuitry configured to:
access, from a memory, a frame comprising a plurality of blocks; and
perform a block matching process for a first block of the plurality of blocks, responsive to an indication that the first block includes text.

2. The apparatus as claimed in claim 1, wherein the video encoding circuitry is further configured to bypass a block matching process for a second block, responsive to an indication that the second block does not include text.

3. The apparatus as claimed in claim 1, wherein responsive to an indication that a second block includes text, the video encoding circuitry is configured to bypass a block matching process for the second block, responsive to the second block including less than a threshold amount of text.

4. The apparatus as claimed in claim 1, wherein the indication further indicates whether the first block includes an amount of text that is greater than a threshold amount.

5. The apparatus as claimed in claim 1, wherein the frame is a reference frame, and wherein the video encoding circuitry is configured to perform a hash value generation process for a given block, responsive to an indication that an amount of text detected at one or more pixel positions corresponding to the given block meets a threshold amount.

6. The apparatus as claimed in claim 5, wherein the video encoding circuitry is configured to bypass the hash value generation process for the given block, responsive to an indication that an amount of text detected at the one or more pixel positions corresponding to the given block does not meet the threshold amount.

7. The apparatus as claimed in claim 1, wherein the indication further indicates an amount of text detected at each pixel position in the frame.

8. A method comprising:
accessing, by a processing circuitry from a memory, a frame comprising a plurality of blocks; and
performing, by the processing circuitry, a block matching process for a first block of the plurality of blocks, responsive to an indication that the first block includes text.

9. The method as claimed in claim 8, further comprising bypassing, by the processing circuitry, a block matching process for a second block, responsive to an indication that the second block does not include text.

10. The method as claimed in claim 8, further comprising performing, by the processing circuitry, the block matching process when encoding video data using an Intra Block Copy (Intra BC) prediction mode.

11. The method as claimed in claim 8, wherein the indication further indicates whether the first block includes an amount of text that is greater than a threshold amount.

12. The method as claimed in claim 8, wherein the frame is a reference frame, and the method further comprises performing, by the processing circuitry, a hash value generation process for a given block, responsive to an indication that an amount of text detected at one or more pixel positions corresponding to the given block meets a threshold amount.

13. The method as claimed in claim 12, further comprising bypassing, by the processing circuitry, the hash value generation process for the given block, responsive to an indication that an amount of text detected at the one or more pixel positions corresponding to the given block does not meet the threshold amount.

14. The method as claimed in claim 8, wherein the indication further indicates an amount of text detected at each pixel position in the frame.

15. A processor comprising:
a memory comprising circuitry configured to store a video frame;
circuitry configured to:
retrieve the frame from the memory; and
divide the frame into a plurality of blocks; and
perform a block matching process for a first block of the plurality of blocks, responsive to an indication that the first block includes text.

16. The processor as claimed in claim 15, wherein the circuitry is further configured to bypass a block matching process for a second block, responsive to an indication that the second block does not include text.

17. The processor as claimed in claim 15, wherein the circuitry is configured to perform the block matching process when encoding video data using an Intra Block Copy (Intra BC) prediction mode.

18. The processor as claimed in claim 15, wherein the frame is a reference frame, and wherein the circuitry is configured to perform a hash value generation process for a given block, responsive to an indication that an amount of text detected at one or more pixel positions corresponding to the given block meets a threshold amount.

19. The processor as claimed in claim 18, wherein the circuitry is configured to bypass the hash value generation process for the given block, responsive to an indication that an amount of text detected at the one or more pixel positions corresponding to the given block does not meet the threshold amount.

20. The processor as claimed in claim 15, wherein the indication further indicates an amount of text detected at each pixel position in the frame.
